(19) United States
(12) Patent Application Publication
(10) Pub. No.: US 2019/0250615 A1
(43) Pub. Date: Aug. 15, 2019

(54) Autonomous Skateboard

(71) Applicant: Carla Gillett, Sacramento, CA (US)

(72) Inventor: Carla Gillett, Sacramento, CA (US)

(73) Assignee: Carla R. Gillett, Sacramento, CA (US)

(21) Appl. No.: 16/365,644

(22) Filed: Mar. 26, 2019

Related U.S. Application Data
(63) Continuation-in-part of application No. 15/379,474, filed on Dec. 14, 2016, now Pat. No. 10,245,936.

(51) Int. Cl. G05D 1/00; G05D 1/02; A63C 17/01; A63C 17/12

(52) U.S. Cl. CPC G05D 1/0088; G05D 1/0212; G05D 1/0234; G05D 1/0246; A63C 2203/12; G05D 1/0257; G05D 1/027; A63C 17/012; A63C 17/12; G05D 1/0255

(57) ABSTRACT

An autonomous skateboard comprising an autonomous controller system comprising software associated with monitoring operational processes of an electric powered truck governed by an environmental sensor array and motion sensors including; load sensors, deformation sensors, gyroscope sensor, and accelerators, accordingly a power control module provides battery power to the electric motors. The autonomous skateboard configured to independently operate with or without an operator riding onboard. The operator uses their smartphone to manually control or verbally control the autonomous skateboard, the operator accesses a mobile app, customizes user preference settings, whereby software algorithms and user interface instructions allow the operator to control their autonomous skateboard when riding, or summon the autonomous skateboard to drive over to her or him, respectively the operator can utilizes their preference settings to select a custom drive mode with max speed calculated. The operator's smartphone is configured with a user interface system linked to the autonomous skateboard by WIFI or Bluetooth, the operation data and performance data gathered by the operator is saved in memory, Cloud management network or both.

### CROSS REFERENCED TO RELATED APPLICATIONS

A notice of issuance for a continuation in part patent application in reference to application Ser. No. 15/379,474; filing date: Dec. 14, 2017; titled “Powered Skateboard System Comprising Inner-Motorized Wheels”; and relating to patent application Ser. No. 13/872,054; filing date: Apr. 26, 2013, title: “Robotic Omniwheel”, and relating to patent application Ser. No. 12/655,569; title: “Robotic Omniwheel Vehicle” filing date: Jan. 4, 2010, U.S. Pat. No. 8,430,192 B2.

### FIELD OF THE INVENTION

The present invention relates to a controller for providing an electric skateboard with autonomous control interface wirelessly linking to user interface. The controller preferably provides path planning to an autonomous skateboard.

### BACKGROUND OF THE INVENTION

Existing electric skateboards work well only for situations relating to sport and stunt riding. What is needed is a smart skateboard with trucks that are controlled by an autonomous control system with minimal user instruction which will allow the electric skateboard to be capable of path planning autonomously and pick its own path by environmental tracking and object detection sensors. New methodologies are required for path planning involve creating novel skateboards which work to follow from a starting point to an ending point by means of autonomous control system sensors and by GPS waypoints which are manually created from user interface input.

### SUMMARY OF THE INVENTION

Thus, the present invention provides a manual control mode and an autonomous control mode selection for an operator not on board, or a rider onboard to control an autonomous skateboard, the autopilot methodology programmed to govern one or more navigation processes of an electric motorized skateboard. Preferably, the autonomous skateboard provides WIFI or Bluetooth linking a user interface system with an autonomous skateboard interface, where in each interface method communicates and receives instructions from the operator/rider, such instructions including tasks for path planning, and gathers environmental sensor data from the autonomous skateboard, the sensor data includes including short range LIDAR sensor, cameras, GPS, etc. for calculating skateboard speed, compass heading, absolute position, relative position, and other environment sensor data. Further, the autonomous skateboard controller includes a processing unit having software for computing logic a central processing unit, memory, storage, communication signals and instruction.

Preferably, the autonomous skateboard interface, the user interface, an environment sensor array and processors are combined as a singular integrated unit, whereby, the rider may temporarily require the use an autopilot system to autonomously control the skateboard so the rider can take break or a potential operator wanted to ride an autonomous skateboard may summon the autonomous skateboard to drive directly to the her or him. While riding, the operator utilizes may engage their smartphone, the rider accesses their user interface settings including electronic identification information and instruction, input and output data, and mechanical identifiers based on machine-readable identification information includes and electronic identifiers, or simply the autonomous scooter automatically controls and detects an operator with respect to the autonomous skateboard.

More specifically, Bluetooth links the operator's smartphone to the autonomous skateboard controlling components, and when riding the rider may utilize a Smartphone APP to select a control mode and program their user preference settings, and/or upon working, monitor the autonomous skateboard's operation of motor speed, a battery level, a compass heading, absolute position and relative position based on GPS local mapping, an odometer or trip meter, and environment sensor data. The operator may wish to upload software or review a summary of the important information useful for operator and store performance data to Cloud management network.

### BRIEF DESCRIPTION OF THE DRAWINGS

FIG. 1A illustrate a perspective view of an autonomous skateboard 100A comprising front and rear differential steering trucks 110(A) according to an aspect of the present invention.

FIG. 1B illustrate a see-through view of an autonomous skateboard 100B, uni-wheel trucks 110(B) comprising a deformation sensor for steering control, and control sensor components according to an aspect of the present invention.

FIG. 2A illustrates a perspective side view of an autonomous skateboard 100 according to an aspect of the present invention.

FIG. 2B illustrates a see-through side view of the platform sections 102, motion sensor array and FIG. 2C illustrates a compartment arrangement in accordance with one or more embodiments of the present invention.

FIG. 3 illustrates a schematic diagram representing a Gravity Control Mode 300 according to an aspect of the present invention.

FIG. 4 schematically illustrates a diagram representing an Autonomous Skateboard Controller System 400 according to an aspect of the present invention.

FIG. 4A and FIG. 4B details a flowchart representing twelve operational processes of an Autonomous Skateboard Controller System 400 according to an aspect of the present invention.

FIG. 5A schematically illustrates a diagram representing a Motion Control Mode 500 disclosing operational processes according to an aspect of the present invention.

FIG. 5B schematically illustrates a flowchart representing operation steps of the Motion Control Mode 500 according to an aspect of the present invention.

FIG. 6A and FIG. 6B schematically illustrate a flowchart representing operation steps of an Autonomous Drive Mode 600 of the Autonomous Skateboard Controller System 400 according to an aspect of the present invention.

FIG. 7 schematically illustrates a diagram representing operations of a Manual Drive Mode 700 of the Autonomous Skateboard Controller System 400 according to an aspect of the present invention.

FIG. 8 schematically illustrates a flowchart 800 representing operations of a User Interface System 800 according to an aspect of the present invention.

FIG. 9 schematically illustrates a diagram representing operations of a Smartphone APP 900 according to an aspect of the present invention.

### DETAILED DESCRIPTION OF THE DRAWINGS

The present invention includes an Autonomous Skateboard Controller System 400 provides autonomous control to many different types of vehicles and now to an electric powered autonomous skateboard 100. Autonomous control means that after initialization, the autonomous skateboard 100 moves and/or accomplishes one or more tasks without further guidance from a human operator 101 whilst onboard riding, has stepped off, or even if the operator 100 is located within a vicinity near an autonomous skateboard 100. The period of full autonomous control may range from a less than a minute to an hour or more. In various aspects the Autonomous Skateboard Controller System 400 is associated with an Autonomous Drive Mode 600 setting and a Manual Drive Mode 700 setting, accordingly the Autonomous Drive Mode 600 or the Manual Drive Mode 700 are engaged or disengaged by an operator's smartphone.

In various riding events, during an operation of an autonomous skateboard 100, the operator 101, in one or more events, may opt to utilize their smartphone 801 to access one or more user interface preference settings via a User Interface System 800 wirelessly linking to a mobile app or “smartphone app”. During a riding event, the autonomous skateboard operator 101 is associated with controlling her or his autonomous skateboard either manually or autonomously, when she or he prefers, for short distances the operator may prefer to manually control their autonomous skateboard, and when riding for longer distances the operator may prefer to not want to manually control their autonomous skateboard therefore she or he can disengage the manual drive and engage the autonomous dive mode, accordingly in any riding event the operator 101 decides a drive mode option.

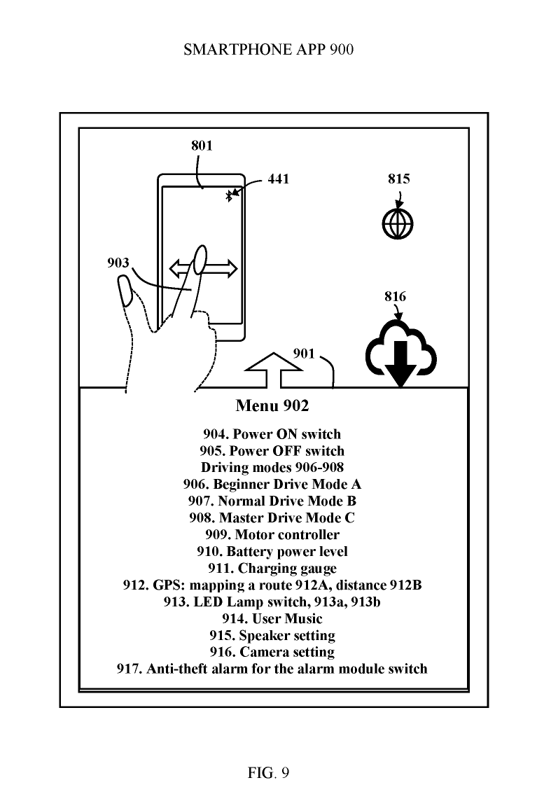

Respectively, the operator 101 of the autonomous skateboard 100A or the autonomous skateboard 100B accesses control settings by her or his Bluetooth connected smartphone 801, the smartphone 801 is configured with user preference settings based on various Smartphone APP software, the software programming is associated with wirelessly controlling one or more electric motors 109 of the autonomous skateboard 100, in retrospect, the Smartphone APP or related mobile app is provided on the internet of things, an example of the Smartphone App 900 is detailed in FIG. 9.

Accordingly hereon the autonomous skateboard controller system 300 may be referred to as (ASCS), the autonomous skateboard 100 may be referred to as (AS) or (AS 100) and the autonomous drive mode 600 may be referred to as (ADM), and the manual drive mode 700 may be referred to as (MDM), and the user interface system 800 may be referred to as (UIS).

Suitable autonomous vehicles such as the autonomous skateboard 100A and the autonomous skateboard 100B include WIFI and/or Bluetooth connectivity adapted for linking the User Interface System 800 (UIS) to the ASCS 400, wherein a built-in Bluetooth communication mode 802 is associated with a communication link between the autonomous skateboard 100 and operator's Smartphone APP 900, and provides a wireless link to one or more environmental sensors and processors associated ASCS drive control methodologies, the AS is detailed herein.

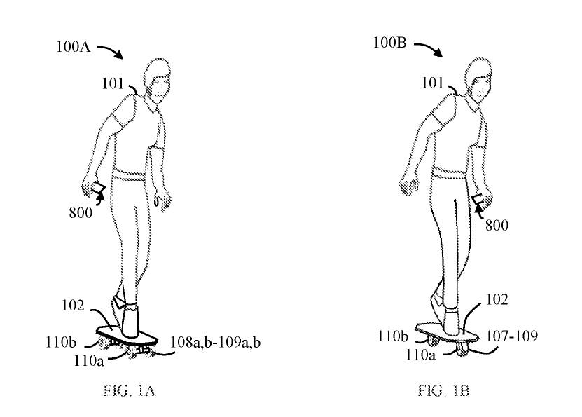

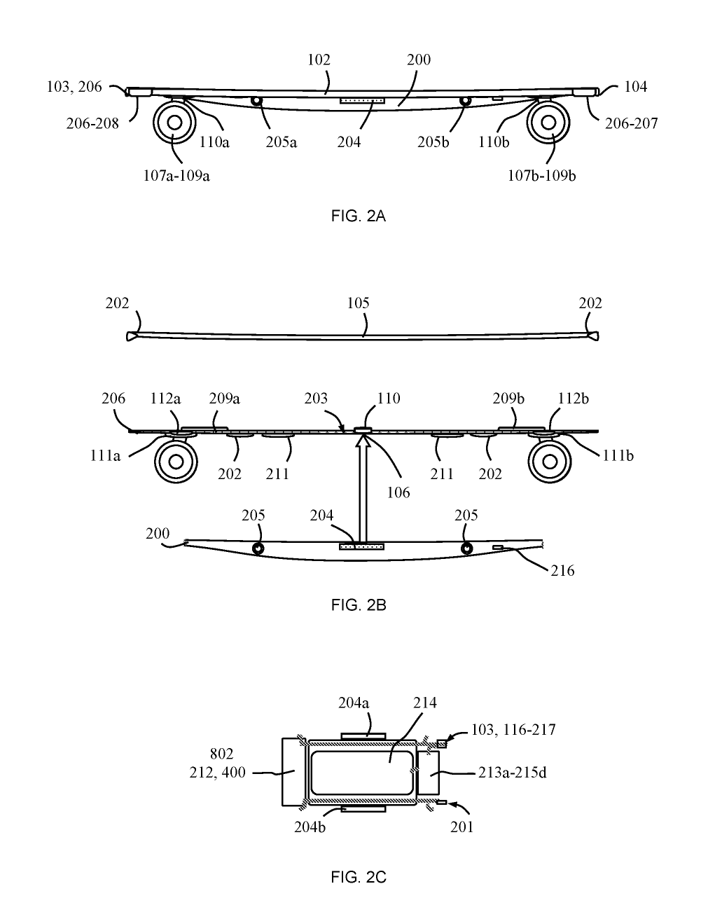

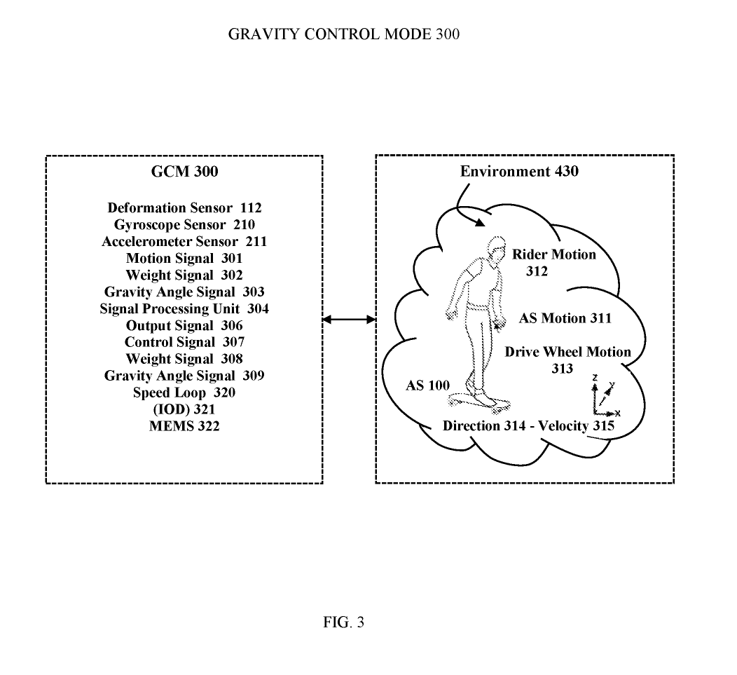

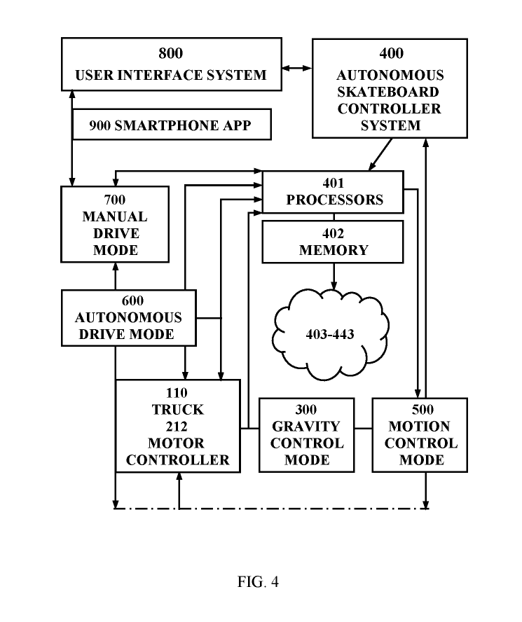

In greater detail FIG. 1A illustrates a perspective view of an autonomous skateboard 100A and an operator of the autonomous skateboard 100A, as shown the operator 101 is exemplified utilizing a smartphone 801 for accessing the ASCS and drive mode settings, furthermore, the autonomous skateboard 100A comprises a platform 102 providing a front end 103 and a rear end 104, a deck section 105 providing a footing placement of the operator 101, and a base section 106 for attaching two opposing trucks 110a-110b, each truck 110a-110b comprising a regenerative braking means 107, a right drive wheel 108a and a left drive wheel 108b configured with an electric motor 109 comprising a motor sensor 109a. Wherein the truck 110 is attached on the front end 103 and on the rear end 104 of the base section 105 by a suspension adapter 111 providing a connection point between the truck and the base section. Accordingly, the front and rear trucks 110a, 110b and the deformation sensors 112a, 112b are connectively wired via a coupling arrangement providing a wiring array 216, subsequently the wiring array 216 associated with linking battery power to all of the ASCS electrical components, see FIG. 2C.

In various elements the drive wheel 108 provides an axle configured to couple the electric motor 109 by bearings and bolting means, accordingly a front truck 110a attaches to a base section 106 situated at the front end 103, and a rear truck 110b attaches to a base section 106 situated at the rear end 104.

In various elements the elongated skateboard platform 102 for providing a front and rear footing placement of the operator 101, and a base section 106 for attaching a front and rear truck 110a, 110b.

In various elements, during manual drive mode 700, the operator 101 is associated with controlling the battery power providing an electric motor a speed control based on the power level regulated, via motor controllers 212, to the front truck 110a and regulated the rear truck 110b electric motor arrangements 109a-109b and manual steering control of the autonomous skateboard 100 is also provided by the operator's 101 riding skill, body posture and footing placement.

In greater detail FIG. 1B illustrates a perspective view of an autonomous skateboard 100B and an operator of the autonomous skateboard 100B, as shown the operator 101 is exemplified utilizing a smartphone 801 for accessing the ASCS and drive mode settings, furthermore, the autonomous skateboard 100B comprises an elongated skateboard platform 102, the platform 102 providing a front end 103 and a rear end 104, a deck section 105 providing a footing placement of the operator 101, and a base section 106 for attaching front and rear truck module(S) 110a, 110b configured with a cantilevered fork arrangement for supporting one drive wheel 108 containing an electric motor 109, the single drive wheel 108 being suspension adapter 111, the front and rear trucks 110a, 110b each contains a deformation sensor 112, the suspension adapter 111 connectively attaches an upper portion of the truck 110 onto front 103 and end 104 portions of the base section 106, respectively the suspension adapter 111a and 111b are connectively wired via a coupling arrangement, the wire array 216 subsequently linking to all of the ASCS electrical components.

In various elements the suspension adapter 111 configured for attaching the truck 110 to a base section 106 of the platform 102, the suspension adapter 111 comprising; a truck plate 111a, a hanger 111b, a bushing 111c, a kingpin 111d that connects the hanger, bushing, and truck plate together, and an axle 111e housed in the hanger 111b.

In one aspect the suspension adapter 111a and 111b are connected on the upper portion autonomous skateboard 100A trucks 110a, 110b, the suspension adapter 111a and 111b are utilized to improve ride comfort, traction, stuck wheels, and reduce rider fatigue.

In one element the deformation sensors 112 may be mounted directly to the suspension adapter 111 and/or mounted on the truck 110 to measure an induced stress caused by the operator's weight.

In one or more elements the deformation sensor 112 is linked to a gyroscope sensor 210, and an accelerometer 211 which controls velocity and other motorized operations of the autonomous skateboard 100, respectively, the deformation sensor 112 associated with the truck 110 is configured to sense strain level 112c induced by a rotation speed and twisting angle differences at a connection point generated at an intersection of the truck 110 and the platforms base section 106 and the deformation sensor 112 to sense strain level induced by a rotation speed and twisting angle differences at a connection point generated at an intersection of a top portion of the truck 110 and the base section 106.

Accordingly the truck 110 utilizes the deformation sensor 112 attached to the suspension adapter 111, the deformation sensor to sense operator weight and center of gravity strain induced by forces exerted upon the front and rear trucks 110a, 110b, and the deformation sensor to sense weight imbalance of the operator's 101 center of gravity to move linearly in response to a balance level of the autonomous skateboard 100 via a gyroscope sensor 210 attached to a section of the platform 101, the gyroscope sensor 210 is configured to sense inclination of the platform 102, when working, respectively the electric motor(s) 109 are configured to drive the wheels 108 only when the autonomous skateboard 100 is properly oriented via one or more load sensors 209 in a reasonable riding position, such as substantially level to the ground.

In greater detail FIG. 2B illustrates the platform 102 comprising internal sensors including load sensors 209a, 209b, the gyroscopic sensor 210 and the accelerometer 211, the load sensor 209 or “orientation sensor” is configured to measure an orientation of the rider's presence on the platform deck section 105. The gyroscopic sensor 210 and accelerometer 211 are adapted to maintain fore-and-aft balancing of the platform 102, and accordingly the preferred battery power level is activated via a motor controller 212 which is electronically linked to an array of Bluetooth connected devices via a wiring array 201 and a USB port 216 situated on the platform 102.

In various connectivity elements, the platform's deck section 105 and the base section 106, wherein the compartment 200 is contained within a platform base section 106, wherein the compartment 200 provides a cavity for containing an electrical wiring array 201 linking to internal devices, wherein the electrical wiring array 201 is connectively linked to a USB port 216, the USB port become connected to an external power source such as AC 110 outlet, via an external USB power cord 217. The electrical wiring array 201 is configured for linking battery power directly to the following Bluetooth devices Bluetooth connected devices including; LED head lamps 202a, LEAD turn signals 202b, braking lamps 202c, a special effects LED cord 203 synchronized to speakers 204, or for brighter illumination, cameras 205, and ASCS environment sensor array including but not limited to; LIDAR sensor 206 (e.g., 2D, 3D, color LIDAR), RADAR 207, sonar 208.

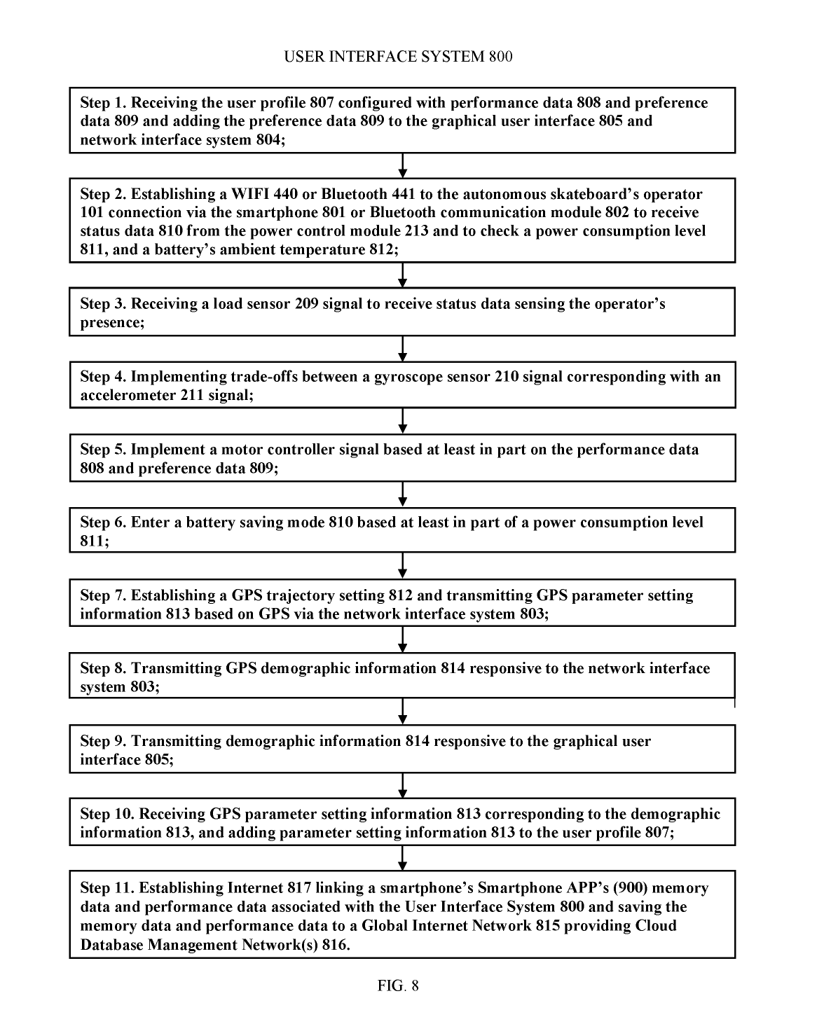

The Bluetooth connected devices, when paired, are linked to the autonomous skateboard controller system 400 by means of a built-in Bluetooth communication module 802, the Bluetooth communication module 802 transmits data signal associated with the motion control sensor array 209-211 and external environment sensor array. The platform 102 and the compartment 200 further contains the wiring array 201 linking to the gyroscopic sensor 210, accelerometer 211, and a motor controller 212. Wherein the platform components via a built-in Bluetooth communication mode 802, the Bluetooth communication module 802 configured as a wireless a link, linking the autonomous skateboard controller system 400 to the user interface system 800, the user interface system being associated with the operator's Smartphone APP 900, detailed in FIG. 8 and FIG. 9.

In greater detail FIG. 2C illustrates a compartment containing one or more removable battery packs 214 set in a series which are charged by a battery charger 215, the battery charger 215 is governed by the power control module 213 providing sensor data 213a, the battery charger 215 providing a charging level 215a and sensor data 213a, said battery charger 215 is electrically linked to a USB port 216 to recharge the battery pack 214 from time to time from an external power outlet source providing external USB power cord 217, the USB power cord 217 can be stored inside the compartment for later use to charge phones and other DC devices.

In various elements the power control module 213 further comprises a receiver 213b and a processor 213c for monitoring the battery charger's a charge level 215a associated with one or more removable battery packs 214 during a charging process. Wherein the battery charger 215, via wiring array 201 connects the battery packs 214 in a series. Respectively, the battery packs 214 when fully charged can be switched out and used later to extend operators riding time, the spent battery pack are placed back in the compartment or recharged later.

Accordingly, the Bluetooth connected devices listed herein attached to platform sections and to compartment portions, wherein the compartment 200 contains an electrical wiring array 202 linking to a battery 214 comprising a power control module 213, and a battery charger 215 the battery charger subsequently connects to the USB power cord 217 and AC outlet or other power source.

Accordingly, the deformation sensor 112 and the internal sensors 209, 210, and 211 are contained between the deck and base sections 103-106, respectively the gyroscopic sensor 210 (with fuzzy logic 210a) and an accelerometer 211 and provide data based on load sensor data 209a, gyroscope sensor data 210a and base on accelerometer sensor data 211a, and the motor controller 212 associated with a server 212a, a processor 212b, and motor controller sensor data 212c. Respectively the gyroscope sensor 210 providing an intelligent weight and motion controlling means, and an accelerometer 211 configured to measure balance which is achieved as soon as the rider steps on the upper deck section 105, subsequently the preferred power level, associated with drive modes, is activated by the motor controller 212.

Respectively, the AS 100 may be self-powered by regenerated power from the electric motors 109, providing a minimal amount of regeneration power is captured to maintain a battery charge level 215a to run the motor controller 212 and allow the low-drag torque control 212d is useful when the battery 214 has been nearly depleted, a regenerative battery charging process is initiated by the braking activity 107 of slowing down or stopping. Accordingly, the velocity of the drive wheels 108 provides a regenerative braking means 107 associated with maintaining a charge level 215a to the battery.

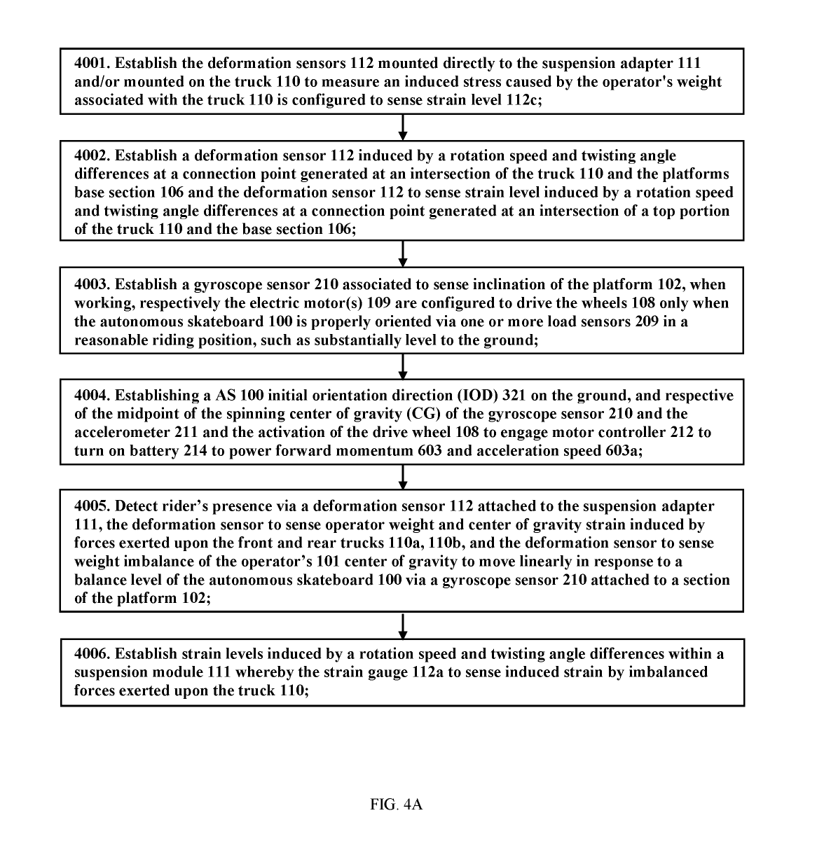

In greater detail FIG. 3A illustrates a control diagram of a Motion Assistant Gravity Control Mode 300 which may include for example, and a deformation sensor 112, a load sensor 209, a gyroscope sensor 210 an accelerometer sensor 211, a motion signal 301, a weight signal 302, a gravity angle signal 303, a signal processing unit 304, an output signal 306, control signal 307, a weight signal 308 and a gravity angle signal 309 environment 430, AS 100 motion 311, an operator motion 312 and the drive wheel's motion 313, direction 315, and velocity 316.

In various environments 430 the gyroscope sensor 210 and the accelerometer sensor 211 may measure a motion signal 301 of an operator's motion 312 by pushing or shaking the foot pad/board of the example on the platform 102 and/or a 3-dimension moving response of the AS's in the x, y, z direction 315 and velocity 316 associated with the operator's motion 312 and/or the example the AS's motion 311.

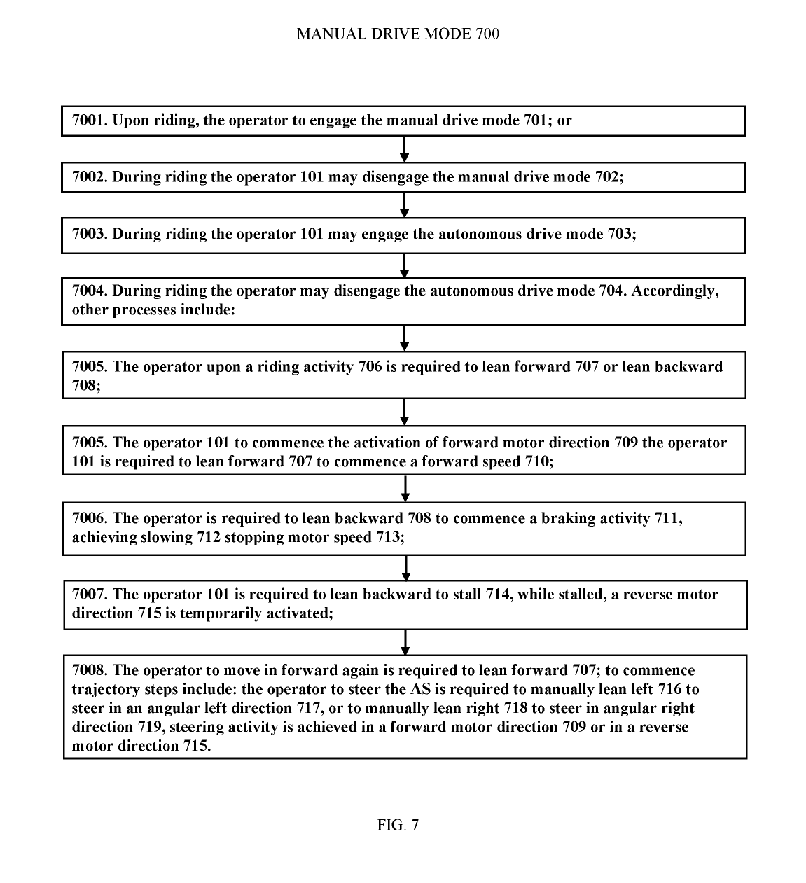

In one example, the motions 311/312 may include a predefined motion input 301, including for example, the operator 101 hopping on and/or off the AS 100. The operator utilizing one or more riding skills to associated with motion control operator 101 which include; to engage a drive mode 701-704, motion to engage propulsion 705-715, and motion to engage trajectory 709, 715, 716-719, see FIG. 7 for further details.

In one example, a deformation sensor 112 may be computed by a weight signal 302 and a gravity angle signal 309 generated from one or more move control signals 307, including for example, forward, backward, accelerate, and/or brake signal 109a from a signal processing unit 304. The signal processing unit 304 may combine and process the deformation output signal 306 providing motion signals 301 to produce the one or more move control signals 307 relayed the autonomous drive mode 600.

In some aspects control signals 307 may control the AS 100 to move in a direction, including for example, a forward direction or a backward direction, or an initial orientation direction (IOD) 321. The direction of the AS's motion 311 may be determined based on the deformation output signal 306 associated with the weight signal 308 and the gravity angle signal 309.

In some aspects control signals may control the speed of the AS 100, for example, to accelerate or braking means 107. In one example, the speed of the AS's motion 311 may be determined based on operator's motion 312, such as shaking the AS 100. In another example, the speed of the AS motion 311 may be determined based on the deformation output signal 306 associated with the weight signal 308 and the gravity angle signal 309. Respectively, the deformation sensor comprises a strain gauge 112a configured to sense induced strain by imbalanced forces exerted upon the drive wheel 108 and the deformation sensor 112 to sense strain level 112b induced by an operator's weight exerted on the deformation sensor 112 to sense strain level induced by a rotation speed and twisting angle differences at a connection point generated at an connection of a suspension adapter 111a of the drive wheel 108a attached on the platform's front end 103, and the deformation sensor 112 to sense strain level induced by a rotation speed and twisting angle differences at a connection point generated at a connection of a suspension adapter 111b of the drive wheel 108b attached on the platform's rear end 104.

Accordingly, the internal motion control sensors 209, 210, and 211 are contained between the deck and base sections 105/106, respectively the gyroscopic sensor 210 (with fuzzy logic 210a) and an accelerometer 211, the load sensor 209 providing data based on gyroscope sensor data 210a and base on accelerometer sensor data 211a, and a motor controller 212 configured having; a server 212a, a processor 212b, sensor data 212c and low-drag torque control 212d. Respectively the gyroscope sensor 210 providing an intelligent weight and motion controlling means via the motor controller 212, and an accelerometer 211 configured to measure balance which is achieved as soon as the operator 101 steps on the upper deck section 105, subsequently when operator 101 dismounts or is not detected on the deck section 105 by load sensors 209a, 209b, and accordingly the preferred power level is activated to furnish battery power to the drive wheel's motor 109 via power control module 213 associated with the motor controller 212.

For example, when a motor controller server 212a is configured to sense the drive wheel 108 speeds and adjust the electric motor 109 torque to keep the drive wheel 108 rotational velocities relatively similar, especially in situations when the right drive wheel 108a has more traction compared to the left drive wheel 108b which may be sensed by a motor controller processor 212b which is configured to read the strain gauge sensors on the electric motors 109 contained therein and determine which drive wheel 108 has more operator 101 weight and therefore more traction.

Another example, when an operator 101 of the autonomous skateboard 100A leans his or her body toward the drive wheel 108a, for example, the front truck's deformation sensor 112a may receive a higher pressure compared with the rear truck's deformation sensor 112b. After signal correction and compensation from the gyroscope sensor 110 and the accelerometer sensor 111 in the motion input 501 according to the environment 330, movement and the operator's motion may be acquired and outputted to the PID control 317 and driving control block 318.

In one example the autonomous skateboard 100A (e. g., whilst in manual drive mode 700) may be steered by the operator 101 by shifting his or her weight to the right or left to complete a right turn or a left turn through the mechanical turn movement of the front truck's 110a first and second drive wheels 108a, 108b, wherein the drive wheel's motors 109a-109b provide drive wheel motion 513.

Primarily, to control the velocity setpoint of the autonomous skateboard 100A speed is determined by using the strain gauge(s) of the deformation sensor 112 to establish the center of gravity (CG) of the operator 101; wherein, when the CG is sensed toward the front truck's two motors 109a-109b the desired speed will be incremented faster in the speed loop 320; and when the CG is sensed toward the rear truck's two motors 109a-109b the desired speed will be decremented slower in the speed loop 320; the rate of increment/decrement may be determined by the amplitude of the CG from center. This method has the advantage of allowing the operator 101 to comfortably stand centered on the board while powering forward at the desired speed. The operator 101 would lean forward to accelerate (increase velocity), lean back to slow down (decrease velocity) until zero speed is reached e. g., braking means 107.

Primarily, to control the velocity setpoint of the autonomous skateboard 100B speed is determined by using the strain gauge(s) of the deformation sensor 112 to sense the center of gravity CG of the operator 101; wherein, when the CG is sensed toward the front truck's one motor 109 the desired speed will be incremented faster in the speed controller loop; and when the CG is sensed toward the rear truck's one motor 109 the desired speed will be decremented slower in the speed loop 320; the rate of increment/decrement may be determined by the amplitude of the CG from center. This method has the advantage of allowing the operator 101 to comfortably stand centered on the board while powering forward at the desired speed. The operator 101 would lean forward to accelerate (increase velocity), lean back to slow down (decrease velocity) until zero speed is reached e. g., braking means 107.

Another control method is to use the above described method to sense CG but to increment or decrement a torque set point in a torque controller loop instead of a speed loop 320. The operator 101 would lean forward to increment the commanded torque set point and lean back to decrement the commanded torque set point; the rate of increment/decrement may be determined by the amplitude of the CG from center.

A selectable option would allow an advanced operator 101 to, when leaning back, also continue in reverse after zero speed is reached, the operator would select to travel in a reverse direction to back up whilst steering left or right.

Another control method is to use the sensed CG to directly control the commanded motor drive torque setpoint. The operator 101 would need to continually lean forward to maintain forward torque and maintain a lean back to apply negative torque.

Another control method is to use the sensed CG to directly control the commanded motor drive velocity setpoint. The operator 101 would need to continually lean forward to maintain forward velocity and lean back to reduce velocity.

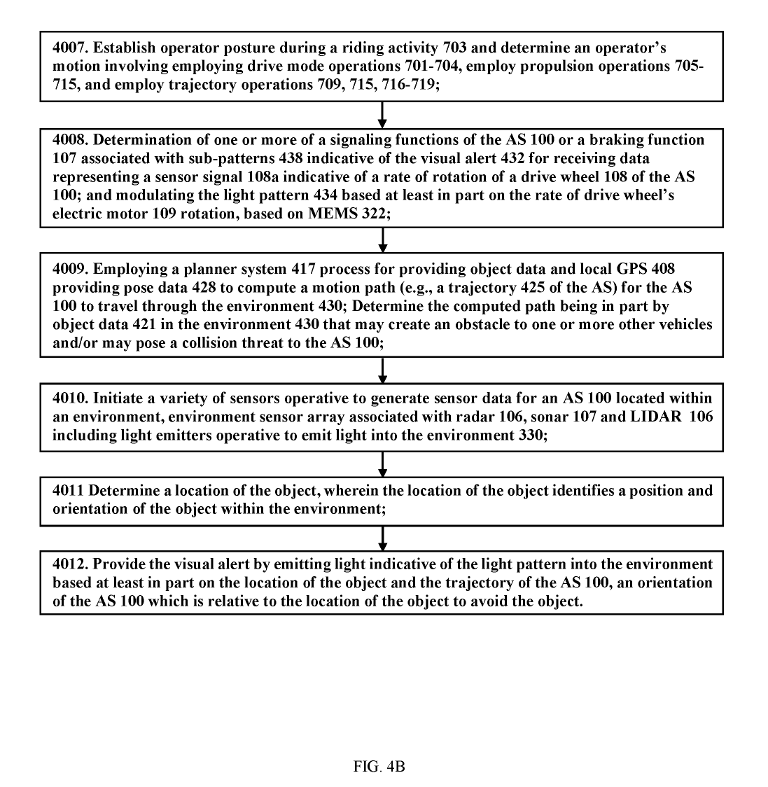

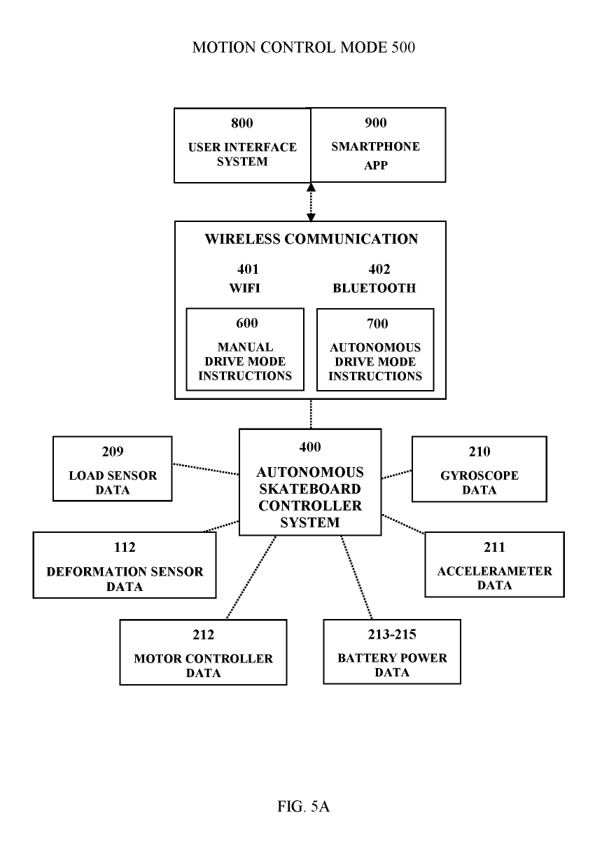

In greater detail FIG. 4 illustrates a diagram representing operations for an Autonomous Skateboard Control System 400 comprising operating processes and sensors configured to detect objects in environment and to determine an object track for objects, classify objects, track locations of objects in environment, and sensors to detect specific types of objects in environment, such as traffic signs/lights, road markings, lane markings and the like. The Autonomous Skateboard Control System 400 comprises one or more processor 401 and memory 402 for storing sensor data 403 provided by an arrangement of environment sensors 106-108, truck 110-212 elements and the power control module 213 contained within the platform 102, the environment sensors associated with ASCS may include but not limited to one or more of; a short-range LIDAR sensor 206, a radar sensor (ARS) 207 are situated on sections of the platform 102, and may utilize sonar 108. The one or more processors being configured to determine a location of the AS 100 in the environment 404, a localizer system 405 may receive sensor data 406 from sensor system. In some examples, sensor data 403 received by localizer system 416 may not be identical to the sensor data 403 received by the perception system 407.

For example, perception system 407 may receive sensor data 403 from one or more external environmental sensor array situated on section of the platform and compartment 200; wherein the LIDAR sensor 206 (e.g., 2D, 3D, color LIDAR), RADAR 207, sonar 208, based on MEMS technology 322, other data is gathered by one or more video cameras 205 (e.g., image capture devices); whereas, localizer system 416 may receive sensor array data 403 including but not limited to global positioning system (GPS) 408 having data including; inertial measurement unit (IMU) data 409, map data 410, route data 411, Route Network Definition File (RNDF) data 412 and odometry data 413, wheel encoder data 414, and map tile data 415. Accordingly, the localizer system 416, having a planner system 417 having memory 418 and may receive object data 419 from sources other than sensor system, such as utilizing memory 418 via a data store, or Cloud Data Management 443 and Performance Management Network 444.

Accordingly perception system 407 may process sensor data 406 to generate object data 419 that may be received by the planner system 417. Object data 419 may include but is not limited to data representing object classification 420, detecting an object type 421, object track 422, object location 423, predicted object path 424, predicted object trajectory 425, and object velocity 426, in an environment 430.

Accordingly the localizer system 416 may process sensor data 403, and optionally, other data, to generate position and orientation data 427, local pose data 428 that may be received by the planner system 417. The local pose data 428 may include, but is not limited to, data representing a location 429 of the AS 100 in the environment 430 via (GPS) 408, (IMU) data 409, map data 410, route data 411, (RNDF) data 412 and odometry data 413, wheel encoder data 414, and map tile data 415, and a global coordinate system 431 for example.

The following implementations described that includes a no matter in motion (such as video), and no matter at rest (still images), and text, graphics, or whether it be a picture of any that may be configured to display the image device. It may be implemented in devices or systems. More specifically, the implementation to be described include, but are not limited to, mobile phones, multimedia Internet enabled cellular telephones, mobile television receiver, a wireless device, smartphone, Bluetooth connected devices, personal digital assistant (PDA), a wireless e-mail receiver, hand-held or portable computers. Teachings herein also include, but are not limited to, electronic switching devices, radio frequency filters, sensors, accelerometers, gyroscopes, motion sensing devices, magnetometers, inertial components for consumer electronics, parts of consumer electronics products varactor, a liquid crystal device, an electrophoretic device, a driving method, such as manufacturing processes and electronic test equipment, can be used in non-display applications. Accordingly, the present teachings, not just limited to the implementation shown in the figures, has instead, a wide easily such that the apparent applicability to those skilled in the art.

A sensor system of the AS 100 comprising processors for determining, based at least in part on the sensor data, a location of the AS 100 within the environment 430, wherein the location 429 of the AS 100 identifies a position and orientation via load sensors 209 of the AS 100 within the environment 430 according to global coordinate system 431.

The ASCS is associated with calculating, based at least in part on the location 429 of the autonomous skateboard 100 and at least a portion of the sensor data 403 a trajectory 425 of the AS 100, wherein the trajectory 425 indicates a planned path associated GPS 408 with navigating the AS 100 between at least a first location 429a and a second location 429b within the environment 430.

The ASCS is associated with identifying, based at least in part on the sensor data 406, an object 421 within the environment 430; and determining a location of the object 421 in the environment 430, wherein the location 429 of the object 421 identifies a position and orientation 427 of the object within the environment according to the global coordinate system 431; and determining, based at least in part on the location 429 of the object 421 and the location of the AS 100, to provide a visual alert 432 from a light emitter 433.

The ASCS is associated with selecting a light pattern 434 from a plurality of light emitter 433 patterns, wherein a first one of light patterns 434 is associated with a first level of urgency of the visual alert, and a second one of the light patterns is associated with a second level of urgency of the visual alert; selecting, from a plurality of light emitters 433 of the AS 100, a light emitter 433 to provide the visual alert 432; and causing the light emitter 433 to provide the visual alert 432, the light emitter emitting light indicative of the light pattern 434 into the environment 430.

The ASCS is associated with calculating, based at least in part on the location of the object 421 and the trajectory 425 of the AS 100, an orientation 427 of the AS 100 relative to the location 429 of the object 406; selecting the light emitter is based at least in part on the orientation of the AS 100 relative to the location 429 of the object.

The ASCS is associated with estimating, based at least in part on the location 429 of the object 421 and the location 429 of the AS 100, a threshold event 435 associated with causing the light emitter 433 to provide the visual alert 432; and detecting an occurrence of the threshold event 435; and wherein causing the light emitter 433 of the AS 100 to provide the visual alert 432 is based at least in part on the occurrence of the threshold event 435.

The ASCS is associated with calculating, based at least in part on the location 429 of the object 421 and the location 429 of the AS 100, a distance between the AS 100 and the object 421; and wherein selecting the light pattern 434 is based at least in part on the distance, threshold event 335 according to a threshold distance 436 or a threshold time, and a second threshold distance 437.

The ASCS is associated with estimating light and configured with a setting for selecting the light pattern 434 is based at least in part on one or more of a first threshold event 435 according to a threshold distance or a threshold time, wherein the first threshold distance 436 is associated with the light pattern 434a and a second threshold distance 437 is associated with a different light pattern 434b, wherein the first threshold distance and the second threshold distance is less than a distance between the object 421 and the AS 100, and wherein the threshold time 436 is shorter in duration as compared to a time associated with the location 429 of the AS 100 and the location of the object being coincident with each other.

The ASCS is associated with calculating, based at least in part on the location 429 of the object 421 and the trajectory 425 of the AS 100, a time associated with the location 429 of the AS 100 and the location of the object being coincident with each other; and wherein causing the light emitter 433 of the AS 100 to provide the visual alert 432 is based at least in part on the time.

The ASCS is associated with determining an object classification for the object 421, the object classification determined from a plurality of object classifications, wherein the object classifications include a static pedestrian object classification, a dynamic pedestrian object classification, an object classification, and a dynamic car object classification; wherein selecting the light pattern 434 is based at least in part on the object 421 classification.

The ASCS is associated with accessing map data associated with the environment 430, the map data accessed from a data store of the AS 100; and determining position data and orientation data associated with the AS 100; and wherein determining the location 429 of the AS 100 within the environment 430 is based at least in part on the map data 410, the position data and the orientation data.

The ASCS is associated with selecting a different light pattern 434 from the plurality of light patterns based at least in part on a first location of the object before the visual alert is provided and a second location of the object after the visual alert is provided, and causing the light emitter 433 to provide a second visual alert, wherein the light emitter emits light indicative of the different light pattern into the environment 430.

Wherein the light emitter 433 includes a sub-section and the light pattern includes a sub-pattern 438 associated with the sub-section 439, the sub-section being configured to emit light indicative of the sub-pattern 438, wherein at least one of the sub-patterns 438 is indicative of one or more of a signaling functions of the AS 100 or a braking function 107 of the AS 100 and wherein at least one other sub-pattern 438 is indicative of the visual alert 432 receiving data representing a sensor signal 108a indicative of a rate of rotation of a drive wheel 108 of the AS 100; and modulating the light pattern 434 based at least in part on the rate of drive wheel's electric motor 109 rotation.

The planner system 417 may process the object data and the local via GPS 408 providing pose data 428 to compute a motion path (e.g., a trajectory 425 of the AS) for the AS 100 to travel through the environment 430. The computed path being determined in part by object data 421 in the environment 430 that may create an obstacle to one or more other vehicles and/or may pose a collision threat to the AS 100.

In various aspects the autonomous skateboard controller system 400 may employ a micro controller or central processors, memory, and sensors array to provide autonomous control to many different types of the autonomous skateboard 100. Autonomous control means that after initialization, the AS 100 moves and/or accomplishes one or more tasks without further guidance from the operator 101, even if the operator 101 is riding the AS 100, or the operator 101 is located within a few steps of the AS 100, or within the vicinity of the AS 100.

The link to an environmental sensor array link to a processing unit which communicates with the ASCS 400. The communication between the ASCS and the AS 100 may be carried on any suitable data bus with CAN (e.g. ISO 11898-1) and/or PWM buses preferred. Wirelessly via WIFI 440 and/or Bluetooth 441 the ASCS 400 synchronously links the user interface system 800 or (UIS) and to the Internet 442, Cloud Data 443 and Performance Management Network 444.

The ASCS 100 for providing autonomous control to a AS 100, comprising: UIS 800 that communicates with the AS 100 and provides instructions to the vehicle regarding acceleration, braking, steering or a combination thereof; the UIS 800 that communicates with and receives instructions from an operator 101, the instructions including task instructions, path planning information or both.

The ASCS is associated with an environmental sensor array 407 that receives sensor data from the AS 100 and communicates the sensor data 421 to the to the UIS such data including AS 100 speed, compass heading, absolute position, relative position or a combination thereof. The autonomous control continues for a period of time of at least one hour after instructions are provided to the operator interface; establish sensor array monitors electric motor operating conditions and battery charge level 215a, and electrical systems or a combination thereof of the AS 100.

The ASCS is associated at least one sensor that monitors motion of the AS 100 including rate of acceleration, pitch rate, roll rate, yaw rate or a combination thereof and the at least one sensor that monitors motion includes the accelerometer, the gyroscope, and the motor controller 212.

The ASCS is associated with programming for path planning to the AS 100 and such path planning includes marking a path of waypoints on a digitized geospatial representation, the waypoints mark a path that is the perimeter of a scan area that the AS 100 then scans; wherein the AS 100 scans the scan area by traveling to waypoints within the scan area, and respectively the ASCS 400 employs a digitized geospatial representation that provides absolute position of the AS 100 in creating the scan area or provides relative position through the use of an ad hoc grid.

In various aspects the ASCS 400 includes a mechanism for receiving communication from a smartphone 801 or the internet 442 such that a user can communicate with the AS 100 through the mechanism.

In greater detail FIG. 4A illustrates a flowchart for the Autonomous Skateboard Controller System 400 applied to the drive and motion processes to: 4001. Establish the deformation sensors 112 mounted directly to the suspension adapter 111 and/or mounted on the truck 110 to measure an induced stress caused by the operator's weight associated with the truck 110 is configured to sense strain level 112c; 4002. Establish a deformation sensor 112 induced by a rotation speed and twisting angle differences at a connection point generated at an intersection of the truck 110 and the platforms base section 106 and the deformation sensor 112 to sense strain level induced by a rotation speed and twisting angle differences at a connection point generated at an intersection of a top portion of the truck 110 and the base section 106; 4003. Establish a gyroscope sensor 210 associated to sense inclination of the platform 102, when working, respectively the electric motor(s) 109 are configured to drive the wheels 108 only when the autonomous skateboard 100 is properly oriented via one or more load sensors 209 in a reasonable riding position, such as substantially level to the ground; 4004. Establishing a AS 100 initial orientation direction (IOD) 321 on the ground, and respective of the midpoint of the spinning center of gravity (CG) of the gyroscope sensor 210 and the accelerometer 211 and the activation of the drive wheel 108 to engage motor controller 212 to turn on battery 214 to power forward momentum 603 and acceleration speed 603a; 4005. Detect rider's presence via a deformation sensor 112 attached to the suspension adapter 111, the deformation sensor to sense operator weight and center of gravity strain induced by forces exerted upon the front and rear trucks 110a, 110b, and the deformation sensor to sense weight imbalance of the operator's 101 center of gravity to move linearly in response to a balance level of the autonomous skateboard 100 via a gyroscope sensor 210 attached to a section of the platform 102; 4006. Establish strain levels induced by a rotation speed and twisting angle differences within a suspension module 111 whereby the strain gauge 112a to sense induced strain by imbalanced forces exerted upon the truck 100.

As shown FIG. 4B continued, 4007. Establish operator posture during a riding activity 703 and determine an operator's motion involving employing drive mode operations 701-704, employ propulsion operations 705-715, and employ trajectory operations 709, 715, 716-719; 4008. Determination of one or more of a signaling functions of the AS 100 or a braking function 107 associated with sub-patterns 438 indicative of the visual alert 432 for receiving data representing a sensor signal 108a indicative of a rate of rotation of a drive wheel 108 of the AS 100; and modulating the light pattern 434 based at least in part on the rate of drive wheel's electric motor 109 rotation; 4009. Employing a planner system 417 process for providing object data and local GPS 408 providing pose data 428 to compute a motion path (e.g., a trajectory 425 of the AS) for the AS 100 to travel through the environment 430; 4010. Determine the computed path being in part by object data 421 in the environment 430 that may create an obstacle to one or more other vehicles and/or may pose a collision threat to the AS 100; 4011. Initiate a variety of sensors operative to generate sensor data for an AS 100 located within an environment, wherein the sensors include LIDAR sensors 106 including light emitters operative to emit light into the environment 330; 4012 Determine a location of the object, wherein the location of the object identifies a position and orientation of the object within the environment. Provide the visual alert by emitting light indicative of the light pattern into the environment based at least in part on the location of the object and the trajectory of the AS 100, an orientation of the AS 100 which is relative to the location of the object to avoid the object.

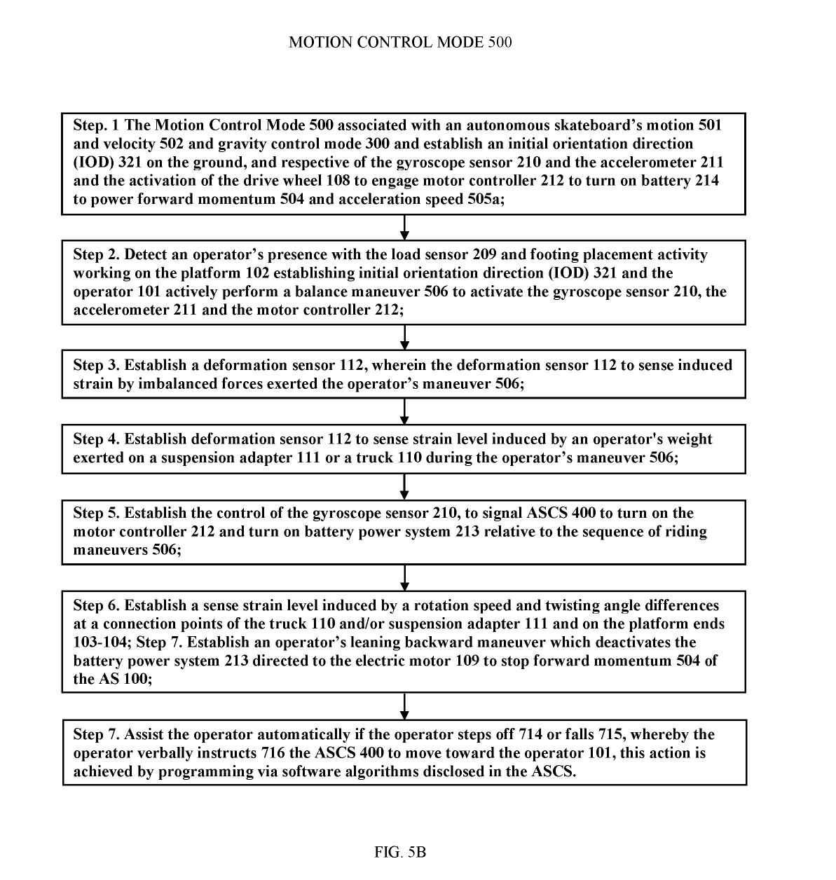

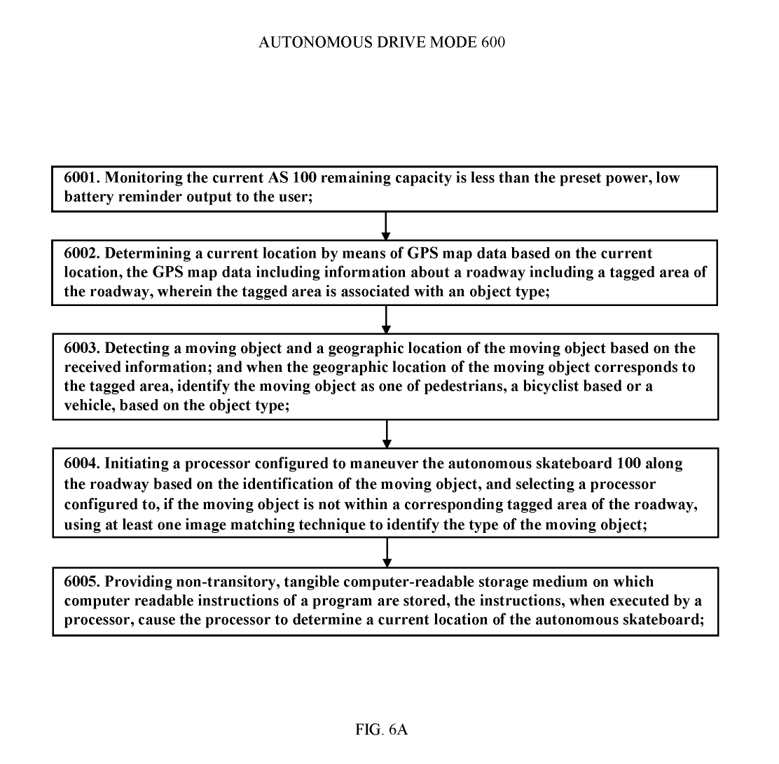

In greater detail FIG. 5 represents a flowchart for a Motion Control Mode 500 associated with an autonomous skateboard's motion 501 and velocity 502 methodologies and Gravity Control Mode 300 comprising: Step 1. Establish an AS 100 initial orientation direction (IOD) 321 on the ground, and respective of the gyroscope sensor 210 and the accelerometer 211 and the activation of the drive wheel 108 to engage motor controller 212 to turn on battery 214 to power forward momentum 504 and acceleration speed 505a; Step 2. Detect an operator's presence with the load sensor 209 and footing placement activity working on the platform 102 establishing initial orientation direction (IOD) 321 and the operator 101 actively perform a balance maneuver 506 to activate the gyroscope sensor 210, the accelerometer 211 and the motor controller 212; Step 3. Establish a deformation sensor 112, wherein the deformation sensor 112 to sense induced strain by imbalanced forces exerted the operator's maneuver 506; Step 4. Establish deformation sensor 112 to sense strain level induced by an operator's weight exerted on a suspension adapter 111 or a truck 110 during the operator's maneuver 506; Step 5. Establish the control of the gyroscope sensor 210, to signal ASCS 400 to turn on the motor controller 212 and turn on battery power system 213 relative to the sequence of riding maneuvers 506; Step 6. Establish a sense strain level induced by a rotation speed and twisting angle differences at a connection points of the truck 110 and/or suspension adapter 111 and on the platform ends 103-104; Step 7. Establish an operator's leaning backward maneuver which deactivates the battery power system 213 directed to the electric motor 109 to stop forward momentum 504 of the AS 100. Step 8. Assist the operator automatically if the operator steps off 714 or falls 715, whereby the operator verbally instructs 716 the ASCS 400 to move toward the operator 101, this action is achieved by programming via software algorithms disclosed in the ASCS.

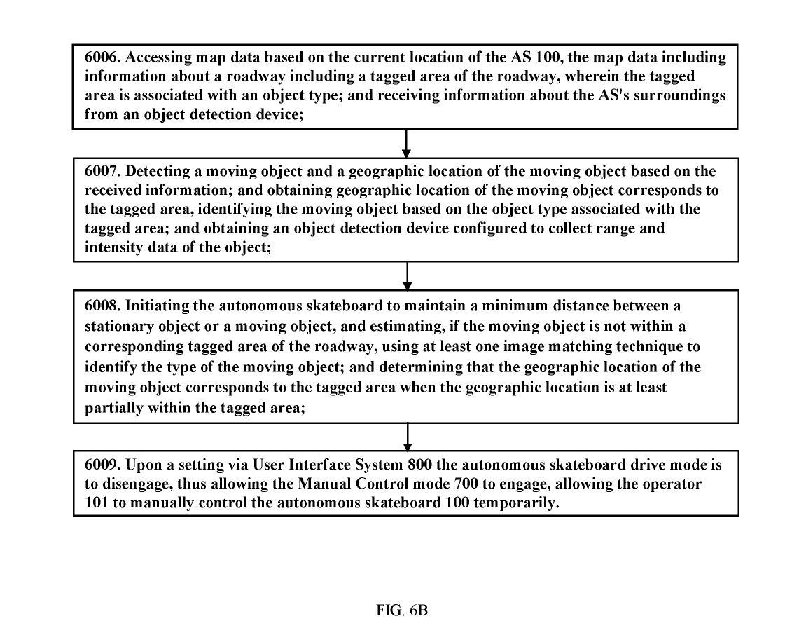

In greater detail FIG. 6 illustrates the Autonomous Drive Mode 600, the system comprising one or more processors for controlling an autonomous skateboard 100 upon operator activation, obtaining the user interface system 700 processors steps comprising: 6001. Monitoring the current AS 100 remaining capacity is less than the preset power, low battery reminder output to the user; 6002. Determining a current location by means of GPS map data based on the current location, the GPS map data including information about a roadway including a tagged area of the roadway, wherein the tagged area is associated with an object type; 6003. Detecting a moving object and a geographic location of the moving object based on the received information; and when the geographic location of the moving object corresponds to the tagged area, identify the moving object as one of pedestrians, a bicyclist based or a vehicle, based on the object type; 6004. Initiating a processor configured to maneuver the autonomous skateboard 100 along the roadway based on the identification of the moving object, and selecting a processor configured to, if the moving object is not within a corresponding tagged area of the roadway, using at least one image matching technique to identify the type of the moving object; 6005. Providing non-transitory, tangible computer-readable storage medium on which computer readable instructions of a program are stored, the instructions, when executed by a processor, cause the processor to determine a current location of the autonomous skateboard; 6006. Accessing map data based on the current location of the AS 100, the map data including information about a roadway including a tagged area of the roadway, wherein the tagged area is associated with an object type; and receiving information about the AS's surroundings from an object detection device; 6007. Detecting a moving object and a geographic location of the moving object based on the received information; and obtaining geographic location of the moving object corresponds to the tagged area, identifying the moving object based on the object type associated with the tagged area; and obtaining an object detection device configured to collect range and intensity data of the object; 6008. Initiating the autonomous skateboard to maintain a minimum distance between a stationary object or a moving object, and estimating, if the moving object is not within a corresponding tagged area of the roadway, using at least one image matching technique to identify the type of the moving object; and determining that the geographic location of the moving object corresponds to the tagged area when the geographic location is at least partially within the tagged area; 6009. Upon a setting via User Interface System 800 the autonomous skateboard drive mode is to disengage, thus allowing the Manual Control mode 700 to engage, allowing the operator 101 to manually control the autonomous skateboard 100 temporarily.

In greater detail FIG. 7 represents a diagram of a Manual Drive Mode 700 representing an operator 101 of an autonomous skateboard 100 utilizing one or more riding skills to employ drive mode operations 701-704, employ propulsion operations 705-715, and employ trajectory operations 709, 715, 716-719. To commence propulsion steps include: 7001. Upon riding, the operator to engage the manual drive mode 701; or 7002. During riding the operator 101 may disengage the manual drive mode 702; 7003. During riding the operator 101 may engage the autonomous drive mode 703; 7004. During riding the operator may disengage the autonomous drive mode 704. Accordingly, other processes include: 7005. The operator upon a riding activity 706 is required to lean forward 707 or lean backward 708; 7005. The operator 101 to commence the activation of forward motor direction 709 the operator 101 is required to lean forward 707 to commence a forward speed 710; 7006. The operator is required to lean backward 708 to commence a braking activity 711, achieving slowing 712 stopping motor speed 713; 7007. The operator 101 is required to lean backward to stall 714, while stalled, a reverse motor direction 715 is temporarily activated; 7008. The operator to move in forward again is required to lean forward 707, to commence trajectory steps include: The operator to steer the AS is required to manually lean left 716 to steer in an angular left direction 717, or to manually lean right 718 to steer in angular right direction 719, steering activity is achieved in a forward motor direction 709 or in a reverse motor direction 715.

In various aspects the autonomous skateboard controller system 400 may be requested by the operator to assist the operator during riding activity 706, whereby, the operator may instruct ASCS 400 to link to a micro-processor or processor of the user interface system 800 to temporary deactivate the manual control mode 700 and switch over to engage the Autonomous Drive Mode 600, thus allowing selective or minimal supervision from the operator 101 thereby the operator discontinues controlling the autonomous skateboard 100 (e. g, semiautonomous), or vice versa, switch over to manual drive and regains control respectively, these driving modes may be alternated over a period of time during riding events.

In various aspects the autonomous skateboard controller system 400 may be required to assist the operator 710 automatically if the operator 101 steps off 714 or falls 715, whereby the operator verbally instructs 716 the ASCS 400 to move toward the operator 101, this action is achieved by programming via software algorithms disclosed in the ASCS.

In various aspects the autonomous skateboard controller system 400 may be employed to provide full autonomous control accomplished without any further guidance from when the operator 101, this action is achieved once the operator disengages the Manual Drive Mode 700.

In one or more elements the communication established between the ASCS and the autonomous skateboards 100A/100B may be carried on any suitable data bus with CAN (e.g. ISO 11898-1) and/or PWM buses, working wirelessly via WIFI and/or Bluetooth, the autonomous skateboard controller system 400 synchronously links the ASCS the user interface system 800 to compute a motion path in one or more environments 430.

In greater detail FIG. 8 exemplifies a User Interface System 800 utilized to establish wireless communication link between an operator 101 of an autonomous skateboard 100 and an autonomous skateboard controller system 400 for controlling said autonomous skateboard 100, the wireless communication link achieved by a smartphone 801 comprising a Bluetooth communication module 802 configured as a wireless a link, linking the autonomous skateboard controller system to the user interface system. Bluetooth communication module 802 also configured for providing computer readable-instructions 803 which are entered by the operator 101. Wherein, the smartphone 801 configured to transmit the operator's 101 computer readable-instructions 803 associated with: a network interface system 804 and a graphical user interface 805 configured with multiple server prompt 806 scenarios associated with following steps: Step 1. Receiving the user profile 807 configured with performance data 808 and preference data 809 and adding the preference data 809 to the graphical user interface 805 and network interface system 804; Step 2. Establishing a WIFI 440 or Bluetooth 441 to the autonomous skateboard's operator 101 connection via the smartphone 801 or Bluetooth communication module 802 to receive status data 810 from the power control module 213 and to check a power consumption level 811, and a battery's ambient temperature 812; Step 3. Receiving a load sensor 209 signal to receive status data sensing the operator's presence; Step 4. Implementing trade-offs between a gyroscope sensor 210 signal corresponding with an accelerometer 211 signal; Step 5. Implement a motor controller signal based at least in part on the performance data 808 and preference data 809; Step 6. Enter a battery saving mode 810 based at least in part of a power consumption level 811; Step 7. Establishing a GPS trajectory setting 812 and transmitting GPS parameter setting information 813 based on GPS via the network interface system 803; Step 8. Transmitting GPS demographic information 814 responsive to the network interface system 803; Step 9. Transmitting demographic information 814 responsive to the graphical user interface 805; Step 10. Receiving GPS parameter setting information 813 corresponding to the demographic information 813, and adding parameter setting information 813 to the user profile 807; Step 11. Establishing Internet 817 linking a smartphone's Smartphone APP's (900) memory data and performance data associated with the User Interface System 800 and saving the memory data and performance data to a Global Internet Network 815 providing Cloud Database Management Network(s) 816.

In greater detail FIG. 9 schematically illustrates a diagram representing a Smartphone APP 900 accordingly, the rider 101 utilizes their smartphone 801 in real time to access the virtual controller settings 901 established from multiple server prompt 806 scenarios which allows an autonomous skateboard operator 101 during Manual Drive Mode 700 to manually control the velocity of one or more electric motors 109 and to manually control the trajectory of the autonomous skateboard in a real time environment with the use of a Smartphone APP 900.

Accordingly, in one or more applications, the Smartphone APP 900 may update future over-the-air software & firmware and manage social media and the internet of things via a Global network 901. The Smartphone APP 900 allows the vehicle rider 101 to select listings on a menu 902 by the finger prompting 903 (i.e., swiping gestures).

Respectively the Smartphone APP 900 controls of the following settings in relation to the virtually controlled electric skateboard components 916 configured to be wirelessly control via user interface, virtual settings listed on the menu 902 as: a power on 903 and off switch 904, a Power switches 905; a Driving modes 906; Beginner Drive Mode A, Normal Drive Mode B, Master Drive Mode C; a Motor controller 907; a Battery power level 908; a Charging gauge 909; GPS 910: a mapping a route 910A, a distance 910B; LED Lamp switch 911/206-207; User Music 912; Speaker setting 913; Camera setting 914; and an Anti-theft alarm for the alarm module switch 915 and Blue tooth connected devices mentioned in FIG. 1-FIG. 4 associated as virtual settings and virtual data in the mobile app.

The smartphone's mobile app communicates between the ASCS wirelessly via WIFI 440 and/or Bluetooth 441 the ASCS 400 synchronously links the user interface system 800 or (UIS) and to the Internet 442, Cloud Data 443 and Performance Management Network 444.

Some implementations provide automatic display mode selection by the reference hierarchy. For example, such an implementation may provide automatic display mode selection for mobile display devices can correspond to a set of each display mode displays the parameter setting, the display parameter setting includes color depth setting, brightness setting (brightness setting), the color gamut setting (color gamut setting), the frame rate setting, contrast setting, gamma setting and obtain. Some implementations may involve a trade-off between the display parameter setting and power consumption. In some instances, one of the criteria may correspond to the application or “application” running on the display device. Various battery status conditions, such as ambient light conditions, may correspond to the display mode. In some implementations, the display parameter setting information, or other device configuration information can be updated according to information received by the display device from another device, such as from the server.

In order to optimize the display criteria for a particular user, some implementations, obtained with the method comprising creating a user profile, and controlling the display such as the display of the mobile display device in accordance with the user profile. In some examples, the display criteria may include brightness, contrast, bit depth, resolution, color gamut, frame rate, power consumption, or gamma. In some implementations, audio performance, touch/gesture recognition, speech recognition, target tracking, in order to optimize the other display device operation, such as head tracking, the user profile may be used. In some such instances, volumes, such as the relative amounts of bass and treble, in order to optimize in accordance with personal hearing profile of the audio settings for mobile display device user (personal hearing profile), user profile. In some implementations, the display parameter setting information, or other device configuration information corresponding to data in a user profile may be received by another device from a display device such as a server. In some examples, the corresponding data in the user profile may include demographic data.

In various implications the operator 101 to understand, various It may provide greatly optimized display settings, and the corresponding level of power consumption to the user with respect to the scenario. Implementations involving user profile, according to the wishes or characteristics of a particular user, can result in additional level of optimization. In some implementations, the default display parameter setting information, can be determined according to a known demographic of users, may be used to control the display without the need of an associated user input. Implementations involving be distributed over a period of time that the process of building a user profile, without placing an excessive burden on the user during the initial setup, the detailed user profile may allow it to be built. For example, a plurality of use of mobile display device, a plurality of illumination conditions and use conditions or may include a plurality of applications used, through a series of brief vision testing or A/B image prompt dispersed over a period of time, limited Although not a substantial amount of information about the visual function of the users, including color perception can be obtained through the display device without imposing a significant burden on the user. In some implementations, the period of time, a plurality of the day, may be a week or a month. To optimize the visual quality of the display for the user, visual function information may be used. In some instances, in order to increase the color intensity of the user to struggle to perceive visual function information may be used. In some implementations, in order to reduce the power user spent on color depth I do not care, may visual function information used to optimize the display power consumption. Furthermore, resulting acquired considerable amount of information about the user's intention that wants to obtain an image quality power and exchange, thereby, it may allow additional display power saving. In some examples, the power can be expressed as a battery life. Some of the user interface disclosed herein include, but are not limited to, information about the user's intention that wants to obtain an image quality in exchange for battery life, user preference information, user information, including visual function information, to allow it to be suitably acquired.

As disclosed in more detail elsewhere herein, some methods may involve obtaining various types of user information for the user profile. Some implementations may involve providing a user prompt for user information and obtaining the user information in response to a user prompt. Some such implementations may involve providing via a mobile display device user prompt for user information. For example, user information, biometric information, the user name, may include user identification information such as a user preference data. In some implementations, in order to associate the user information to a specific user profile, user identification information may be used. For example, it may be useful to distinguish user information obtained from a plurality of users of a single mobile display device.

Some user information, the user to respond to prompts, without the need for such entering the information may be obtained “passively”. For example, some user information, how, when, or where mobile display device may be obtained according to whether used. Such user information, the setting of the user selection, mobile display device location information or the mobile display device is used for an application type, mobile display devices that run on the content or mobile display device provided by a mobile display device time, mobile display device may include environmental conditions used. In some instances, setting the user selection for mobile display devices, text size setting may include brightness setting, or audio volume setting. According to some implementations, environmental conditions may include a temperature or ambient light intensity. As in the user information obtained through the user response, information can be passively acquired over a number of time periods which may include the use of mobile display devices.

Some implementations may allow a plurality of user profiles user maintenance. For example, the user may generally have habitual access to outlet to charge the mobile display device. During such time, the user, in accordance with a first user profile prefer the display image quality than battery life, it may want to try to control the mobile display device settings.

The preference data in a user profile. In some such implementations, such as a user profile stored in the memory of the mobile display device may involve creating or updating a user profile maintained locally via the network interface of the mobile display device, it may also involve sending a user profile information to another device. For example, other devices may be capable of creating or updating a user profile server.

The user interface system is the portion of the ASCS that communicates with the operator required to provide instructions, as shown in FIG. 9.

Another class of sensors includes antennae for sending and receiving information wirelessly, and includes RF, UWB and antennae for communications such as discussed elsewhere in this application. RFID tags may also be used to send and receive information or otherwise identify the vehicle. Moreover, RFID tags may also be used to receive positioning information or receive instructions and/or task performing information.

Preferably, the sensors are solid state devices based on MEMS technology as these are very small, are light weight and have the necessary accuracy while not being cost prohibitive. Each utilized sensor provides a suitable output signal containing the information measured by the sensor. The sensor output signal may be in any data format useable by the processing unit, but preferably will be digital. Furthermore, wireline or wireless communication links may be utilized to transfer signals between the sensor array and the processing unit.

For all communication that takes place within the ASCS or between the ASCS and outside components, any suitable protocol may be used such as CAN, USB, Firewire, JAUS (Joint Architecture for Unmanned Systems), TCP/IP, or the like. For all wireless communications, any suitable protocol may be used such as standards or proposed standards in the IEEE 802.11 or 802.15 families, related to Bluetooth, WiMax, Ultrawide Band or the like. For communication that takes place between the ASCS and a central computer, protocols like Microsoft Robotics Studio or JAUS may be used. For long range communication between the ASCS and the operator, existing infrastructure like internet or cellular networks may be used. For that purpose, the ASCS may use the IEEE 802.11 interface to connect to the internet 422 or may be equipped with a cellular modem.

In greater detail FIG. 9 schematically illustrates a diagram representing a Smartphone APP 900 accordingly, the operator 101 utilizes their smartphone 801 to access the virtual controller settings 901 which allows operator 101 to control one or more Bluetooth devices with their Smartphone APP 900. Accordingly, the Smartphone APP 900 which can update future over-the-air software & firmware and manage social media and the internet of things via a Global network 901. The Smartphone APP 900 allows the vehicle rider 101 to select Bluetooth connected devices; 102-211 virtual versions, accessible on a menu 902 by the finger prompting 903 (i.e., swiping gestures).

Respectively the Smartphone APP 900 controls of the following settings in relation to the virtually control setting; 904. Power ON switch, 905 Power OFF switch 905, Driving modes 906-908, Beginner Drive Mode A 906, Normal Drive Mode B 907, Master Drive Mode C 908, Motor controller 909, Battery power level 910, Charging gauge 911, GPS 912: mapping a route 912A, distance 912B, LED Lamp switch, 913a, 913b, User Music 914, Speaker setting 915, Camera setting 916, Anti-theft alarm for the alarm module switch 917.

The present invention also comprises a method of path planning for an AS Path planning is providing a plurality of waypoints for the AS to follow as it moves. With the current method, path planning can be done remotely from the AS, where remotely means that the human operator is not physically touching the AS and may be meters or kilometers away from the vehicle or locating the operator 101.

The method of path planning comprises marking a path of waypoints on a digitized geospatial representation and utilizing coordinates of the way points of the marked path. Marking a path comprises drawing a line from a first point to a second point.

Any of several commercially available digitized geospatial representations that provide absolute position (e.g. GPS coordinates) may be used in this method and include Google Earth and Microsoft Virtual Earth. Other representations with absolute position information may also be used such as those that are proprietary or provided by the military.

Moreover, digitized geospatial representations with relative position information may also be used such as ad hoc grids like those described in U.S. Patent Publication 20050215269. The ad hoc grids may be mobile, stationary, temporary, permanent or combinations thereof, and find special use within building and under dense vegetative ground cover where GPS may be inaccessible. Other relative position information may be used such as the use of cellular networks to determine relative position of cell signals to one another.

Combinations of ASCS absolute and relative position information may be used, especially in situations where the AS travels in and out of buildings or dense vegetation.

The ASCS 400 coordinates of the waypoints of the marked path are then utilized, whether that means storing the data for later use, caching the data in preparation for near term use or immediately using the data by communicating the data to an outside controller (e.g. an ASCS). For example, the data may be communicated to the processing unit of the ASCS, such as through the operator interface. The processing unit may then issue instructions through the use interface system 800 to operate the AS, or otherwise store the data in the processing unit.

Moreover, other types ASCS path planning may also be utilized for example, recording the movement of the vehicle when operated by a human could be used to generate waypoints. Other types of manual path planning may also be used. In addition, path planning may be accomplished through the use of image recognition techniques. For example, planning a path based on a camera 105 mounted to the platform 102 to avoid objects. In another embodiment, path planning may be accomplished identifying portions of a digitized geospatial representation that is likely to indicate a road or street suitable for the AS to travel on.

With any type of path planning, the generated waypoint data may be manipulated through hardware or software to smooth the data, remove outliers or otherwise clean up or compress the data to ease the utilization of the data.

Moreover, the marked path may include boundary conditions (e.g. increasingly hard boundaries) on either side of the path to permit the AS to select a path that avoids objects that may be found on the original marked path.

In various aspects the autonomous skateboard controller system 400 may employ a micro controller or central processors, memory, sensors to provide autonomous control to many different types of the autonomous skateboard 100. Autonomous control means that after initialization, the vehicle moves and/or accomplishes one or more tasks without further guidance from a human operator, even if the human operator is located on or within the vicinity of the autonomous skateboard 100.

The ASCS also includes an operator interface. The operator interface is the portion of the AS that communicates with the operator (e.g., a human being or central computer system). For all autonomous AS's, at some point, a human operator is required to at least initiate or re-initiate the vehicle. To do this, the operator interface receives instructions (e.g., voice instruction or virtual finger gestures) from the operator, as shown in FIG. 9.

Another class of sensors includes antennae for sending and receiving information wirelessly, and includes RF, UWB and antennae for communications such as discussed elsewhere in this application. RFID tags may also be used to send and receive information or otherwise identify the vehicle. Moreover, RFID tags may also be used to receive positioning information or receive instructions and/or task performing information.

Preferably, the sensors are solid state devices based on MEMS technology 322 as these are very small, are light weight and have the necessary accuracy while not being cost prohibitive. Each utilized sensor provides a suitable output signal containing the information measured by the sensor. The sensor output signal may be in any data format useable by the processing unit, but preferably will be digital. Furthermore, wireline or wireless communication links may be utilized to transfer signals between the sensor array and the processing unit.

For all communication that takes place within the ASCS or between the ASCS and outside components, any suitable protocol may be used such as CAN, USB, Firewire, JAUS (Joint Architecture for Unmanned Systems), TCP/IP, or the like. For all wireless communications, any suitable protocol may be used such as standards or proposed standards in the IEEE 802.11 or 802.15 families, related to Bluetooth, WiMax, Ultrawide Band or the like. For communication that takes place between the ASCS and a central computer, protocols like Microsoft Robotics Studio or JAUS may be used. For long range communication between the ASCS and the operator, existing infrastructure like internet or cellular networks may be used. For that purpose, the ASCS may use the IEEE 802.11 interface to connect to the internet or may be equipped with a cellular modem.

The link to an environmental sensor array link to a processing unit which communicates with the autonomous skateboard controller system 300 (ASCS). The communication between the ASCS and the autonomous skateboards 100A/100B may be carried on any suitable data bus with CAN (e.g. ISO 11898-1) and/or PWM buses preferred. Wirelessly via WIFI and/or Bluetooth the autonomous skateboard controller system 300 synchronously links the skateboard interface system 600 with the user interface system 800.

Throughout the present disclosure, a particular embodiment of the example may be initiated in a range format. Range of type descriptions are merely for convenience and brevity and should not be construed as an inflexible limitation on the disclosed range.

The described embodiments of the invention are intended to be merely exemplary and numerous variations and modifications will be apparent to those skilled in the art. All such variations and modifications are intended to be within the scope of the present invention as defined in the appended claims.

1. An autonomous skateboard comprising:
a platform, wherein the platform comprising a sensor array and a truck array, wherein trucks including one or more electric motors, a power control module,
an autonomous skateboard controller system providing an environmental sensor array;
wherein said platform comprising Bluetooth module linking to smartphone, Internet, Cloud, objects in an environment or a combination thereof;
motion control sensor array including; a deformation sensor, a load sensor, an accelerometer sensor, a gyroscope sensor;
a user interface system interface that communicates with an autonomous skateboard and provides instructions to said autonomous skateboard regarding acceleration, braking, steering, trajectory or a combination thereof;
wherein said environmental sensor array receives sensor data from said autonomous skateboard controller system and communicates the sensor data to said user interface system such data including said autonomous skateboard operator motion, autonomous skateboard motion, velocity, trajectory or a combination thereof;
a processing unit having software for communicating with said autonomous skateboard, said user interface system, said, platform motion sensor array, environmental sensor array or a combination thereof;
an autonomous drive mode providing autonomous control to said autonomous skateboard for a period of time;
a manual control mode providing semiautonomous control or manual control to said autonomous skateboard for a period of time;
wherein said user interface system that communicates with and receives instructions from an operator, the instructions including task instructions, path planning information or both;
wherein said user interface system that wirelessly communicates truck array, power control module, gravity control mode associated with motion sensor array and environmental sensor array or a combination thereof;
wherein said user interface system wirelessly communicates with operator via WIFI or Bluetooth linked smartphone, wherein said user interface system associated with a Smartphone APP;
wherein Smartphone APP for connecting user to said autonomous skateboard controller system.

2. The autonomous skateboard of claim 1 in which said platform further comprising:
a compartment 200 is contained within a section of said platform, wherein the compartment containing an array of internal devices, motion control sensor and external environment sensor array, a motor controller, a built-in Bluetooth communication module;
an electrical wiring array linking to an array of devices, sensor array;
wherein said Bluetooth communication module linking the autonomous skateboard controller system to the user interface system, the user interface system being associated with the operator's Smartphone APP;
one or more removable battery packs set in a series which are charged by a battery charger, wherein the battery charger is governed by the power control module providing sensor data, charging data or a combination thereof;
said electric wiring array electrically linked to a USB port to an external power source.

3. The autonomous skateboard of claim 1 wherein said autonomous skateboard controller system monitors motor controller operating conditions associated with electric motor, battery level, power control module, charging battery or a combination thereof.

4. The autonomous skateboard of claim 1 in which said platform further comprising wiring array, LED lamps, speakers, wherein said LED lamps, speakers, truck, sensor array, cameras, batteries link to wiring array and are contained within or attached to a section of said platform.

5. The autonomous skateboard of claim 1 wherein said user interface system communicates with said autonomous skateboard controller system via WIFI or Bluetooth, wherein said Bluetooth communication module links said autonomous skateboard to operator's smartphone.

6. The autonomous skateboard of claim 1 said autonomous skateboard controller system further comprising:
a gravity control mode, configured to establish an autonomous skateboard initial orientation direction (TOD) on the ground, speed, trajectory, position information, sensor array information or a combination thereof;
said gravity control mode comprising:
load sensors to detect an operator's presence;
the gyroscope sensor to detect operator actively performing balance maneuver, steering maneuver or a combination thereof;
the accelerometer to engage motor controller to turn on battery to power forward momentum, acceleration speed;
the deformation sensor to sense induced strain by imbalanced forces exerted the operator's maneuvers;
wherein said deformation sensor to sense strain level induced by an operator's weight exerted on a suspension adapter, on a truck or a combination thereof;
wherein the gyroscope sensor to signal ASCS to turn on the motor controller, turn on battery power system relative to the sequence of riding maneuvers.

7. The autonomous skateboard of claim 1 said autonomous skateboard controller system further comprising:
a motion control mode configured to:
establish a sense strain level induced by a rotation speed and twisting angle differences of an operator's leaning forward which activates the battery power directed to an electric motor, leaning backward which deactivates the battery power directed to an electric motor;
establish a sense strain level induced by a rotation speed and twisting angle differences of an operator's leaning back to stall which changes a forward motor direction into a reverse motion direction;
wherein the deformation sensor to sense the center of gravity (CG) of the operator; wherein, when the CG is sensed toward a desired speed incremented faster or slower by a speed controller loop; the rate of increment/decrement may be determined by the amplitude of the CG from center;
upon riding the operator to comfortably stands centered on the AS while powering at the desired speed, there upon the operator to lean forward to accelerate (increase velocity), to lean back to slow down (decrease velocity) until zero speed is reaching a braking means of the electric motor drive torque setpoint;
wherein the sensor array includes at least one sensor that monitors motion of the autonomous skateboard including rate of acceleration, pitch rate, roll rate, yaw rate or a combination thereof and the at least one sensor that monitors one or more drive wheel motors.

8. The autonomous skateboard of claim 1, wherein said environmental sensor array receives sensor data from said autonomous skateboard controller system and communicates the sensor data to said user interface system such data including said autonomous skateboard operator motion and autonomous skateboard motion providing velocity, trajectory or a combination thereof.

9. The autonomous skateboard of claim 1, wherein the environmental sensor array includes one or more autonomous skateboard devices; collision avoidance sensors, a LIDAR, short range sonar, short range radar, a camera based system or a combination thereof.

10. The autonomous skateboard of claim 1, wherein the environmental sensor array processors associated with waypoints mark a path that is the perimeter of a scan area that the autonomous skateboard then scans.

11. The autonomous skateboard of claim 1 wherein said autonomous skateboard controller system configured to:
initiate a variety of sensors operative to generate sensor data for an autonomous skateboard located within an environment, wherein the sensors include LIDAR sensors including light emitters operative to emit light into the environment;
determine a location of the object, wherein the location of the object identifies a position and orientation of the object within the environment;
provide the visual alert by emitting light indicative of the light pattern into the environment based at least in part on the location of the object and the trajectory of the autonomous skateboard, an orientation of autonomous skateboard which is relative to the location of the object to avoid the object.

12. The autonomous skateboard of claim 1, said the environmental sensor array further associated:
wherein the autonomous skateboard controller system is programmed to provide path planning to the autonomous skateboard and such path planning includes sensor array marking a path of waypoints on a digitized geospatial representation;
wherein the waypoints mark a path that is the perimeter of a scan area that the autonomous skateboard sensor array then scans;
wherein the sensor array scans the scan area by traveling to waypoints within the scan area;
wherein said autonomous skateboard controller system employs a digitized geospatial representation that provides absolute position of the autonomous skateboard in creating the scan area or provides relative position through the use of the sensor array.

13. The autonomous skateboard of claim 1, wherein the autonomous skateboard controller system further comprising:
software, processors, memory, storage, wireless communication or a combination thereof;
wherein software programmed to provide path planning to the autonomous skateboard and such path planning includes marking a path of waypoints on a digitized geospatial representation;
wherein a processor configured to, if the moving object is not within a corresponding tagged area of the roadway, using at least one image matching technique to identify the type of the moving object, determine a current location of the autonomous skateboard;
wherein a processor to monitor the current or remaining capacity of battery power, low battery reminder output to the user;
determine a current location by means of GPS map data based on the current location, the GPS map data including information about a roadway detect a moving object and a geographic location of the moving object based on the received information.

14. The autonomous skateboard of claim 1, wherein the autonomous drive mode configured for:
providing non-transitory, tangible computer-readable storage medium on which computer readable instructions of a program are stored, the instructions;
accessing map data based on the current location, the map data including information about a roadway including a tagged area of the roadway;
detecting a moving object and a geographic location of the moving object based on the received information;
obtaining geographic location;
identify the type of the moving object; and determining that the geographic location of the moving object corresponds to the tagged area when the geographic location is at least partially within the tagged area;
wherein upon a setting via user interface system the autonomous skateboard drive mode is to disengage, thus allowing the manual control mode to engage, allowing the operator to manually control the autonomous skateboard temporarily;
wherein initiate instruction of the user interface system, via said autonomous skateboard drive mode, to disengage, thus allowing the manual control mode to engage, allowing the operator to manually control the autonomous skateboard temporarily.

15. The autonomous skateboard of claim 1, wherein the manual control mode processes to:
upon riding to engage the manual drive mode, disengage the manual drive mode, engage the autonomous drive mode, or a combination thereof;
lean forward to commence a forward speed, lean backward to commence a braking activity for achieving slowing or stopping motor speed, lean backward to stall, while stalled to reverse motor direction, lean left to steer in an angular left direction, lean right to steer in angular right direction or a combination thereof;
to summon the autonomous skateboard to drive directly to her of him, to summon meaning verbal instruction via smartphone, via Smartphone APP virtual instruction or a combination thereof.

16. The autonomous skateboard of claim 1, wherein the processing unit having software for communicating with said autonomous skateboard and thus to allow operator to summon the autonomous skateboard, said user interface system, said, platform motion sensor array, environmental sensor array or a combination thereof to obtain information from objects in environment surround said autonomous skateboard whilst said autonomous skateboard is independently operating without an operator riding onboard.

17. The autonomous skateboard of claim 1 wherein said user interface system configured for:
establishing a WIFI or Bluetooth connection for wirelessly communicating with operator, receiving the user profile configured with performance data, preference data, adding the preference data to the graphical user interface, network interface system or a combination thereof;
establishing Internet, linking a smartphone's Smartphone APP's;
establishing memory data and performance data associated with user interface system;
wherein memory storage includes a removable data storage so that stored data can be retrieved in the absence of wireline or wireless communications network, Internet or a combination thereof;
saving the memory data and performance data to a Global Internet Network providing Cloud Database Management Network(s).

18. The autonomous skateboard controller system comprising:
an environmental sensor array to obtain information from objects in environment surround an autonomous skateboard;
a user interface system interface that communicates with an autonomous skateboard;
wherein said user interface provides instructions to autonomous skateboard regarding acceleration, braking means, steering, trajectory by one or more autonomous skateboard motion sensor devices;
wherein the user interface system that communicates with and receives instructions from an operator, the instructions including task instructions, path planning information or both;
wherein said user interface system that wirelessly communicate, via WIFI or built in Bluetooth module communication module linked to operators' smartphone;
wherein implementing Bluetooth communication module to receive or transmit operational status data associated with the autonomous skateboard;
wherein calibrate a power control module, to check a power consumption level, battery's ambient temperature;
wherein establish communicating GPS trajectory setting, GPS parameter setting information, GPS demographic information responsive to a global network system;
transmitting demographic information responsive to the graphical user interface, adding parameter setting information to the user profile;
wirelessly communicate, via WIFI or Bluetooth linked smartphone, wherein said user interface system associated with a Smartphone APP, with sensor array, truck array, power control module, autonomous skateboard controller system, environmental sensor array or a combination thereof;
wherein said user interface system comprising a processing unit having software for communicating with an autonomous skateboard and thus to allow operator to summon the autonomous skateboard verbally via smartphone;
an environmental sensor array to obtain information from objects in environment surround said autonomous skateboard whilst said autonomous skateboard is independently operating without an operator riding onboard.

19. An autonomous skateboard user interface system comprising:
a mobile app linking an autonomous skateboard controller system with the user interface system;
a mobile app receiving instructions from an operator of said autonomous skateboard, the instructions including motion controlling instructions, path planning instruction or a combination thereof;
a mobile app obtaining a customized user profile configured with performance data, preference data, adding the preference data to the graphical user interface, network interface system or a combination thereof;
a mobile app implementing a load sensor signal to receive status data sensing the operator's presence;
a mobile app implementing trade-offs between a gyroscope sensor signal corresponding with an accelerometer signal;
a mobile app implementing a motor controller signal based at least in part on the performance data, preference data;
a mobile app implementing a battery saving mode based at least in part of a power consumption level;
a mobile app a power control module, to check a power consumption level, battery's ambient temperature;
a mobile app communicating GPS trajectory setting, GPS parameter setting information, GPS demographic information or combination thereof;
a mobile app transmitting demographic information responsive to the graphical user interface, adding parameter setting information to the user profile;
a mobile app establishing Internet, linking a smartphone's Smartphone APP's an application;
a mobile app establishing a WIFI or Bluetooth connection, accessing Internet;
a mobile app establishing memory data and performance data associated with user interface system;
a mobile app saving the memory data and performance data to a Global Internet Network providing Cloud Database Management Network;
a mobile app connecting user to said autonomous skateboard controller system's Bluetooth communication module to receive status data from operator's smartphone;
a mobile app to virtually access or govern operations of one or more autonomous skateboard control modes;
a mobile app associated with update future over-the-air software and firmware;
manage social media music, via the internet of things provided by global network;
a mobile app to engage processing unit having software associated for communicating with said autonomous skateboard controller system to link to environmental sensor array;
obtain information from objects in environment surrounding said autonomous skateboard;
a mobile app comprising processors providing battery charge status;
a mobile app comprising processors providing charging level data.

20. The autonomous skateboard controller system of claim 1, claim 18, claim 19 further comprising:
software associated with an autonomous skateboard controller system, the software programming providing algorithm for one or more mobile apps monitoring operational processes of said autonomous skateboard;
software associated with an autonomous skateboard controller system, the software programming providing algorithm for said autonomous skateboard sensor array, truck array, power control module, autonomous skateboard controller system, environmental sensor array or a combination thereof;
software associated with an autonomous skateboard controller system, the software programming providing algorithm for said autonomous skateboard to independently operate without an operator riding onboard;
software associated with an autonomous skateboard controller system, the software programming providing algorithm for operator to summon the autonomous skateboard verbally via smartphone;
software associated with an autonomous skateboard controller system, the software programming providing algorithm for said autonomous skateboard to independently operate without an operator riding onboard;
software associated with an autonomous skateboard controller system, the software programming providing algorithm configured for operator instruction, one such instruction, to summon an autonomous skateboard, via autonomous drive mode, to autonomously drive over to her or him;
user preference settings, operation performance, user performance data or a combination thereof to store data as memory in a Cloud network.
